(19) United States
(12) Patent Application Publication
(10) Pub. No.: US 2006/0046652 A1
(43) Pub. Date: Mar. 2, 2006

(54) Short distance wireless setting system and method for automatic transfer function of mobile phones

(75) Inventors: Wei Han, Shanghai City (CN); Tony Tsai, Hsinchu (TW); David Ho, Sanchung City (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 10/930,862

(22) Filed: Sep. 1, 2004

(51) Int. Cl. H04M 1/00

(52) U.S. Cl. 455/41.2; 455/41.3

(57) ABSTRACT

A short distance wireless setting system and method aim to set automatic transfer function for at least one mobile phone. The setting system includes a short distance transmission module and a short distance receiving module. The short distance transmission module is located in a transfer phone to transmit the telephone number data thereof. The short distance receiving module is located in the mobile phone to receive the telephone number data of the transfer phone. After the short distance receiving module has received the telephone number data of the transfer phone, the mobile phone is set to automatic transfer to the telephone number of the transfer phone.

### FIELD OF THE INVENTION

The present invention relates to a short distance wireless setting system and method and particularly to a short distance wireless setting system and method for setting automatic transfer function in at least one mobile phone.

### BACKGROUND OF THE INVENTION

The flourishing of telecommunication industry provides tremendous conveniences to people in communication. With arriving of the mobile communication age, every one who carries a mobile phone can communicate efficiently with other people anywhere.

While the mobile phone is convenient to carry and slim and light, it is not as comfortable as the fixed line phone when talking to other people. Moreover, the mobile phone receives and transmits signals through base stations by wireless communication. It is not as clear and reliable as the fixed line phone. Some high level fixed line phones have special functions not available on the smaller mobile phone. Hence some users often take the advantages of automatic transfer function to transfer the mobile phone to a nearby (short distance) fixed line phone to receive incoming call. Such a transferable fixed line phone will be referred as a transfer phone hereinafter.

However in the conventional technique the transfer function is set manually. It requires procedures as follow: start the mobile phone transfer function; set the phone number of the fixed line phone to be transferred; finally confirm the setting. As the buttons on the mobile phone are few and small, manual operation for the setting is tedious and troublesome. The risk of input error is high. It is time-consuming to do the setting. In the event that the mobile phone user has to move and change locations frequently, the disadvantages mentioned above could give the user a lot of troubles.

### SUMMARY OF THE INVENTION

Therefore the primary object of the invention is to provide a short distance wireless setting system to automatically setting transfer function for at least one mobile phone to overcome the problems mentioned above. The short distance wireless setting system and method provided by the invention aims to resolve the problems as troublesome, error-prone and time-consuming occurred to the conventional technique that setting transfer function manually and provide efficient, automatic and instant transfer setting function for the mobile phone.

Another object of the invention is to provide efficient, automatic and instant transfer setting function of mobile phones for mobile phone users who have to change location frequently.

The short distance wireless setting system and method provided by the invention can set automatic transfer function for at least one mobile phone. The short distance wireless setting system includes a short distance transmission module and a short distance receiving module. The short distance transmission module is located in a transfer phone to transmit telephone number data thereof. The short distance receiving module is located in the mobile phone to receive the telephone number data of the transfer phone. After the short distance receiving module of the mobile phone receives the telephone number data of the transfer phone, the mobile phone sets automatic transfer to the phone number of the transfer phone.

By means of the mobile phone automatic transfer function of the invention, in the range of a short distance local area network (LAN) the mobile phone can set automatic transfer to the phone number of the transfer phone. Hence the invention can eliminate the problems such as troublesome, error-prone and time-consuming occurred to the manual operation. For mobile phone users who change location frequently the invention provides an efficient, automatic and instant mobile phone transfer setting function.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1a is a schematic view of the short distance wireless setting system of the invention.

FIG. 1b is a flow chart of the short distance wireless setting method of the invention.

FIG. 2a is a schematic view of a first embodiment of the invention.

FIG. 2b is a flow chart of the setting method of the first embodiment of the invention.

FIG. 3a is a schematic view of a second embodiment of the invention.

FIG. 3b is a flow chart of the setting method of the second embodiment of the invention.

### DESCRIPTION OF THE PREFERRED EMBODIMENTS

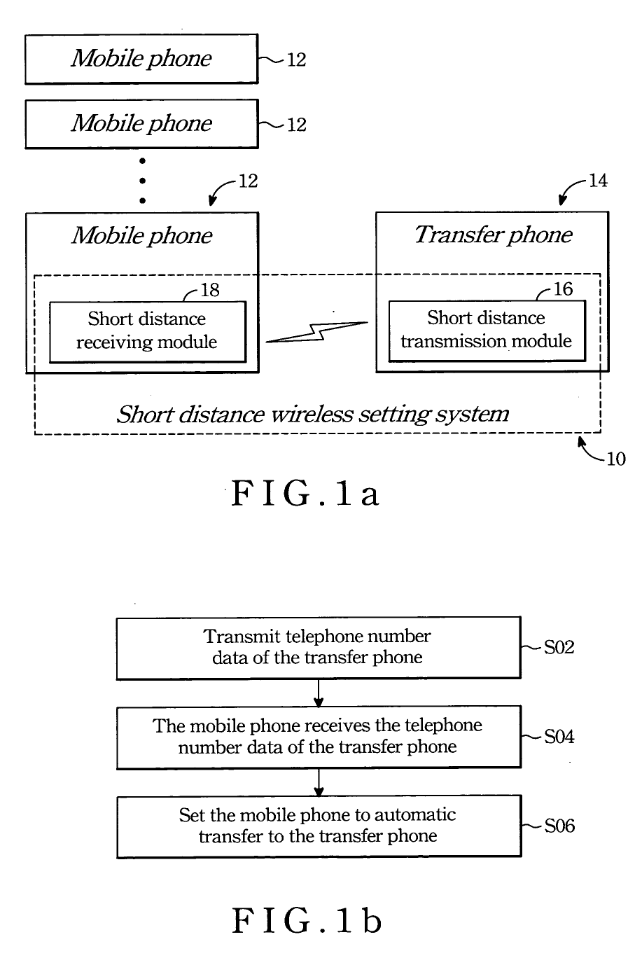

Refer to FIG. 1a for a short distance wireless setting system 10 of the invention. It aims to provide automatic setting of automatic transfer function for at least one mobile phone 12 in the range of a LAN. It includes a short distance transmission module 16 and a short distance receiving module 18.

The short distance transmission module 16 is located in a transfer phone 14 to transmit the telephone number data of the transfer phone 14. The short distance receiving module 18 is located in the mobile phone 12 to receive the telephone number data of the transfer phone 14. The short distance transmission module 16 and the short distance receiving module 18 may adopt Bluetooth wireless modules or IEEE 802.11 wireless communication network standards or other short distance wireless communication modes. After the short distance receiving module 18 of the mobile phone 12 receives the telephone number data of the transfer phone 14, the mobile phone 12 sets automatic transfer to the phone number of the transfer phone 14.

Refer to FIG. 1b for the process of the short distance wireless setting method according to the invention. When the mobile phone 12 is brought within the range of a LAN, and data transmission and receiving through the short distance wireless module is enabled, the automatic transfer function may be set on the mobile phone 12. The procedure includes: Step S02: transmit the telephone number data of the transfer phone 14 through the transfer phone 14. Transmission and receiving of the telephone number data of the transfer phone 14 may be accomplished through Bluetooth wireless modules or IEEE 802.11 wireless communication network standards or other short distance wireless communication modes; Step S04: the mobile phone 12 receives the telephone number data of the transfer phone 14; Step S06: set the mobile phone 12 to automatic transfer to the transfer phone 14 according to the telephone number data.

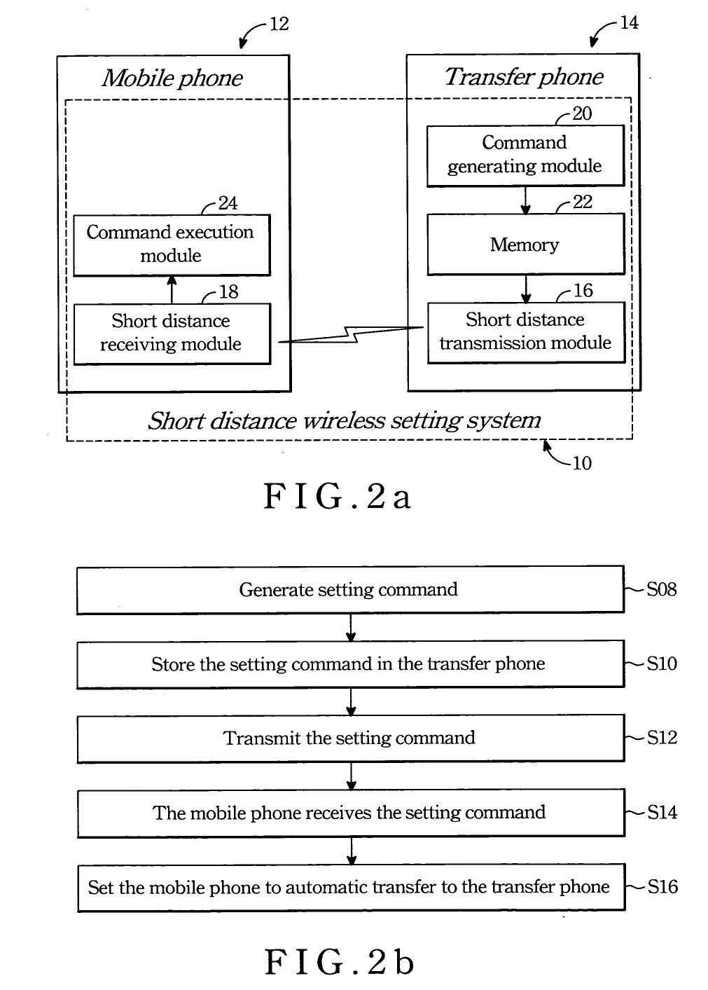

Refer to FIG. 2a for a first embodiment of the invention. The short distance wireless setting system 10 previously discussed further includes a command generating module 20, a memory 22 and a command execution module 24. The command generating module 20 is located in the transfer phone 14 to generate a setting command. The setting command is an AT command. Referring to FIG. 1a, the setting command includes the telephone number data and a transfer command which directly orders the mobile phone 12 to execute the transfer function. The memory 22 is located in the transfer phone 14 to store the setting command. The setting command of the transfer phone 14 is transferred by the short distance transmission module 16, and is received by the short distance receiving module 18 of the mobile phone 12. The execution module 24 is located in the mobile phone 12 to set the mobile phone 12 to automatically transfer to the telephone number of the transfer phone 14 according to the telephone number data after the short distance receiving module 18 has received the telephone number data.

Refer to FIG. 2b for the process of the method according to the first embodiment. It includes the following procedure: Step S08: generate the setting command which is an AT command developed by Hayes Co. to execute modem hardware setting. It is a commonly used standard now adopted by most vendors at present. The AT command includes telephone number data and transfer command which can directly order the mobile phone 12 to perform transfer function; Step S10: the transfer phone 14 stores the command; Step S12: like Step S02, transmit the setting command stored in the transfer phone 14; Step S14: like Step S04, the mobile phone 12 receives the setting command; Step S16: the mobile phone 12 sets the automatic transfer phone number to that of the transfer phone 14 according to the received transfer command and the telephone number data.

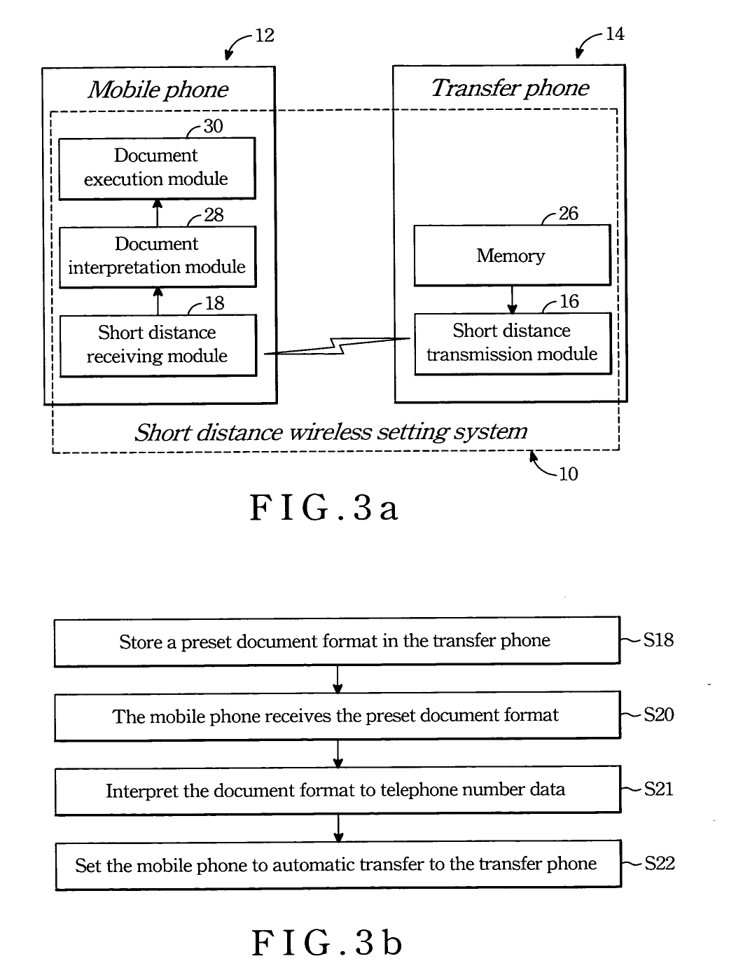

Refer to FIG. 3a for a second embodiment of the invention. In this embodiment the telephone number data in the short distance wireless setting system 10 is a preset document format. The mobile phone 12 further includes a memory 26, a document interpretation module 28 and a document execution module 30. The memory 26 is located in the transfer phone 14 to store the preset document format which is a Vcard format. The document interpretation module 28 is located in the mobile phone 12. After the short distance receiving module 18 has received the preset document format, the document format is interpreted as the telephone number data. The document execution module 30 is located in the mobile phone 12 to execute setting of the telephone number data interpreted by the document interpretation module 28 and set the mobile phone 12 to automatic transfer to the telephone number of the transfer phone 14.

An example of the Vcard document format is given below: the document format name (file name): sample.vcf. The content is as follow:
BEGIN: VCARD
VERSION: 2.2
TEL; CALLFORWARD; VOICE: +1-213-555-1234
END: VCARD

Based on the content of the sample.vcf, when the mobile phone 12 is within the effective range where the transfer phone 14 can transmit the sample.vcf document format, and the phone number of the transfer phone 14 is +1-213-555-1234, the short distance receiving module 18 of the mobile phone 12 receives sample.vcf, and the document interpretation module 28 interprets that the document format is a telephone number +1-213-555-1234; the document execution module 30 sets the mobile phone 12 to automatic transfer to +1-213-555-1234 so that the user of the mobile phone 12 can communicate and talk to the caller on the transfer phone 14 at the phone number of +1-213-555-1234.

Refer to FIG. 3b for the process of the method according to the second embodiment. The telephone number data is a preset document format such as a Vcard document format. The method for the short distance wireless setting includes the following procedure: Step S18: store in advance the preset document format in the Vcard document format in the transfer phone 14; proceed steps S02 and S03 for transmission and receiving operations; S20: the mobile phone 12 receives the preset document format; Step S21: the mobile phone 12 interprets the document format as the telephone number data; Step S22: the mobile phone 12 executes the interpreted telephone number data and sets the mobile phone 12 to automatic transfer to the telephone number of the transfer phone 14.

Therefore by means of the automatic transfer function of the mobile phone 12 provided by the invention, in a short distance within the range of a LAN the mobile phone 12 is set to automatic transfer to the telephone number of the transfer phone 14. As a result, the disadvantages of troublesome, error-prone and time-consuming occurred to the manual operation may be eliminated. For the user of the mobile phone 12 who changes location frequently the invention offers an efficient, automatic and instant transfer function on the mobile phone 12.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A short distance wireless setting system for setting automatic transfer function for at least one mobile phone, comprising:
a short distance transmission module located in a transfer phone to transmit telephone number data of the transfer phone; and
a short distance receiving module located in the mobile phone to receive the telephone number data of the transfer phone;
wherein the mobile phone is set to automatic transfer to the telephone number of the transfer phone after the short distance receiving module having received the telephone number data of the transfer phone.

2. The short distance wireless setting system of claim 1, wherein the short distance transmission module and the short distance receiving module are Bluetooth short distance wireless modules.

3. The short distance wireless setting system of claim 1, wherein the short distance transmission module and the short distance receiving module are short distance wireless modules conforming to IEEE 862.11 wireless communication network standards.

4. The short distance wireless setting system of claim 1 further including:
a memory located on the transfer phone to store a setting command, the short distance transmission module transmitting the setting command of the transfer phone that is received by the short distance receiving module of the mobile phone; and
a command execution module located in the mobile phone to set the mobile phone to automatic transfer to the transfer phone according to the telephone number data received by the short distance receiving module after the short distance receiving module having received the setting command.

5. The short distance wireless setting system of claim 4 further including a command generating module located in the transfer phone to generate the setting command.

6. The short distance wireless setting system of claim 4, wherein the setting command is an AT command.

7. The short distance wireless setting system of claim 1, wherein the telephone number data is a preset document format, the mobile phone further including:
a memory located in the transfer phone to store the preset document format;
a document interpretation module located in the mobile phone to interpret the document format to the telephone number data after the short distance receiving module having received the preset document format; and
a document execution module located in the mobile phone to execute setting of the telephone number data interpreted by the document interpretation module to set the mobile phone to automatic transfer to the telephone number of the transfer phone.

8. The short distance wireless setting system of claim 7, wherein the document format is a Vcard document format.

9. A short distance wireless setting system located in a transfer phone for setting automatic transfer function for at least one mobile phone, comprising:
a short distance transmission module to transmit telephone number data of the transfer phone, the mobile phone having a short distance receiving module to receive the telephone number data of the transfer phone and set the mobile phone to automatic transfer to the telephone number of the transfer phone.

10. The short distance wireless setting system of claim 9, wherein the short distance transmission module and the short distance receiving module are Bluetooth short distance wireless modules.

11. The short distance wireless setting system of claim 9, wherein the short distance transmission module and the short distance receiving module are short distance wireless modules conforming to IEEE 802.11 wireless communication network standards.

12. The short distance wireless setting system of claim 9 further including:
a memory located in the transfer phone to store a setting command, the short distance transmission module transmitting the setting command of the transfer phone that is received by the short distance receiving module of the mobile phone to set the mobile phone to automatic transfer to the transfer phone according to the telephone number data received by the short distance receiving module.

13. The short distance wireless setting system of claim 12 further including a command generating module located in the transfer phone to generate the setting command.

14. The short distance wireless setting system of claim 12, wherein the setting command is an AT command.

15. The short distance wireless setting system of claim 9, wherein the telephone number data is a preset document format, the mobile phone further including:
a document interpretation module to interpret the document format to the telephone number data after the short distance receiving module having received the preset document format; and
a document execution module to execute setting of the telephone number data interpreted by the document interpretation module and set the mobile phone to automatic transfer to the telephone number of the transfer phone.

16. The short distance wireless setting system of claim 15, wherein the document format is a Vcard document format.

17. A short distance wireless setting system located in a mobile phone for setting automatic transfer function for the mobile phone, comprising:
a short distance receiving module to receive telephone number data of a transfer phone transmitted from a short distance transmission module located in the transfer phone, the mobile phone being set to automatic transfer to the telephone number of the transfer phone after the short distance receiving module having received the telephone number data of the transfer phone.

18. The short distance wireless setting system of claim 17, wherein the short distance transmission module and the short distance receiving module are Bluetooth short distance wireless modules.

19. The short distance wireless setting system of claim 17, wherein the short distance transmission module and the short distance receiving module are short distance wireless modules conforming to IEEE 802.11 wireless communication network standards.

20. The short distance wireless setting system of claim 17 further including:
a command execution module located in the mobile phone to set the mobile phone to automatic transfer to the transfer phone according to the telephone number data received by the short distance receiving module after the short distance receiving module having received a setting command from the transfer phone.

21. The short distance wireless setting system of claim 20 further including a command generating module located in the transfer phone to generate the setting command.

22. The short distance wireless setting system of claim 20, wherein the setting command is an AT command.

23. The short distance wireless setting system of claim 17, wherein the telephone number data is a preset document format, the mobile phone further including:
a document interpretation module located in the mobile phone to interpret the document format to the telephone number data after the short distance receiving module having received the preset document format from the transfer phone; and
a document execution module located in the mobile phone to execute setting of the telephone number data interpreted by the document interpretation module to set the mobile phone to automatic transfer to the telephone number of the transfer phone.

24. The short distance wireless setting system of claim 23, wherein the document format is a Vcard document format.

25. A short distance wireless setting method for setting automatic transfer function for at least one mobile phone, comprising the steps of:
transmitting telephone number data of a transfer phone from the transfer phone;
receiving the telephone number data of the transfer phone by the mobile phone; and
setting the mobile phone to automatic transfer to the transfer phone according to the telephone number data.

26. The method of claim 25, wherein the transmitting and the receiving of the telephone number data are accomplished through Bluetooth short distance wireless modules.

27. The method of claim 25, wherein the transmitting and the receiving of the telephone number data are accomplished through short distance wireless modules conforming to IEEE 802.11 wireless communication network standards.

28. The method of claim 25 further including the steps of:
pre-storing a setting command in the transfer phone;
transmitting the setting command;
receiving the setting command by the mobile phone; and
setting the mobile phone to automatic transfer to the transfer phone according to the received telephone number data.

29. The method of claim 28 further including generating the setting command prior to the pre-storing a setting command.

30. The method of claim 28, wherein the setting command is an AT command.

31. The method of claim 25, wherein the telephone number data is a preset document format, the method further including the steps of:
pre-storing the preset document format in the transfer phone;
receiving the preset document format by the mobile phone and interpreting the preset document format to the telephone number data; and
executing setting of the interpreted telephone number data in the mobile phone and setting the mobile phone to automatic transfer to the telephone number of the transfer phone.

32. The method of claim 31, wherein the document format is a Vcard document format.
